(19) United States
(12) Patent Application Publication
(10) Pub. No.: US 2020/0266685 A1
(43) Pub. Date: Aug. 20, 2020

(54) RAIL CAR AXLE GENERATOR

(71) Applicant: Railway Equipment Company, Inc., Minneapolis, MN (US)

(72) Inventor: David Fox, Boca Grande, FL (US)

(21) Appl. No.: 16/639,687

(22) PCT Filed: Aug. 17, 2018
(86) PCT No.: PCT/US18/46969

§ 371 Date: Feb. 17, 2020

Related U.S. Application Data
(60) Provisional application No. 62/546,942, filed on Aug. 17, 2017.

(51) Int. Cl. H02K 7/18; B61D 43/00; H02K 7/08; H02P 9/00

(52) U.S. Cl. CPC H02K 7/1846; B61D 43/00; H02P 2101/40; H02P 9/006; H02K 7/083

(57) ABSTRACT

The present application discloses various apparatuses including generators for rail cars and controllers for use with such generators. Methods related to such generators are also disclosed. According to one embodiment a generator that is mountable to a rotatable axle of the rail car is disclosed. The generator can include: a shaft rigidly coupled to the rotatable axle for rotation therewith, a set of magnets coupled to the shaft for rotation, and a stator assembly mounted on one or more bearing assemblies. The stator assembly is independent of a stationary portion of the rail car so as to be moveable relative thereto with movement of the axle. The stator assembly can include: a set of coils supported by the stator assembly and positioned proximate to the set of magnets to generate electricity when the set of magnets rotates; and an electrical conductor to provide the generated electricity to the rail car.

### CLAIM OF PRIORITY

This application claims the benefit of U.S. Provisional Patent Application Ser. No. 62/546,942 filed on Aug. 17, 2017, the benefit of priority of which is claimed hereby, and which is incorporated by reference herein in its entirety.

### BACKGROUND

Rail cars are being contemplated with functionality that requires electrical power to operate. Prior attempts to provide electrical power include the use of solar and battery power. However, solar power is not easily implemented on all types of rail cars, and further is subject to vandalism, such as graffiti. Batteries are expensive and need periodic replacement or recharging. There have been attempts to electrically connect cars within an assembled train. Given the existing fleet of cars within the industry and the random nature of cars in a train, where cars go through classification yards and are re-assembled randomly, there is no practical way to provide a continuous electrical connection within or among the cars of an assembled train. Within rail cars the wheel/axle assemblies wear over time and are frequently replaced. As such the wheel/axle assembly must easily detach from the car. In fact, the wheel/axle assembly is held in place by a bearing adapter within the side frame, with no secure means of attachment. The entire rail car can be lifted off of its axles without any disassembly.

Hot bearing journals on the axle can be a significant cause of derailment and the industry has thousands of hot bearing detection systems installed along the rail right of way. These detectors scan the underside of the bearing on the axle as the car passes over the detector. As such, the underside of the bearing must remain clearly visible to the detector. The axle is held loosely in place by a bearing adaptor which is held in the side frame, loosely as well. Because of the flexible nature of the positioning of the axle within the adaptor and side frame, there will be variations of the position of the axle relative to adjoining parts of the truck assembly.

### SUMMARY

The present inventor proposes a generator that is rigidly mounted on an axle of a rail car. In particular, the generator can have a rotor assembly coupled to rotate with the axle of the rail car. Such coupling can be accomplished by a shaft, such as a stub shaft, which can be connected back to the axle via an axle end plate, for example. The generator can be configured to move along with the axle relative to stationary portion(s) of the rail car. As used herein the term “stationary portion(s)” is used to connote any portion of the rail car that is non-rotating during operation (movement of the rail car down the track). Thus, the stationary portion(s) are non-rotatable portions (i.e. portions of the wheel bearing, wheel bearing adaptor, side frame, etc.). Additionally, the generator is not rigidly connected or otherwise affixed to the stationary portion(s) but is rather provided with a flexible connection that is only used to restrain any rotation of the generator that could result from rotation of the axle. However, this flexible connection can allow for variation in the position of the generator relative to the stationary portion(s) of the rail car. Thus, as used herein the term “flexible connection” or “flexible linkage assembly” connotes a connection or assembly that allows for some degree of variation in the position of the generator relative to the stationary portion(s) of the rail car. Therefore, the generator can be supported entirely by the axle via the stub shaft.

The generator can include a stator assembly having one or more components such as a set of coils (positioned to interface with a set of magnets carried by the rotor assembly) and an electrical conductor. One or more bearings can maintain a precise dimensional relationship between the set of coils and the set of magnets. A linkage assembly can extend from the stationary portion(s) of the rail car to closely interface with the stator assembly. The linkage assembly can be used to maintain a position of the stator assembly (e.g., prevent the stator from rotating with the rotor assembly). However, as discussed above and according to one embodiment, the generator can be supported entirely by the shaft, which is coupled to the axle rather than the stationary portion(s) of the rail car.

The present inventor recognizes that a generator(s) mounted to rail cars can provide electrical power to car supported electronics. Such electronics can include a microprocessor based controller to be used for sensing the condition of the car, identification of the car, and other functions requiring power to operate. In one embodiment, electrical pulses from the generator(s) can be counted by the electronics to help identify a broken axle or other conditions. Still further, the electronics may be used to release air from airbrakes to engage the brakes on each car upon electrical or wireless command from an operator.

### BRIEF DESCRIPTION OF THE DRAWINGS

FIG. 1A is a block schematic diagram of a cross-section of an assembly that includes an axle, a wheel, a wheel bearing, a wheel bearing adaptor, an axle end cap and a generator according to an example embodiment.

FIG. 1B shows the assembly of FIG. 1A as a block schematic diagram from a second perspective but without the wheel or axle illustrated.

FIG. 2A is side view of a portion of a rail car including a side frame and two wheels with two generators coupled to two axles according to an example embodiment.

FIG. 2B is top view of side frame with the two generators (the two wheels and two generators of FIG. 2A are not shown) according to an example embodiment.

FIG. 3 is a side view of the portion of the rail car with the side frame and two wheels of FIG. 2A with the two generators removed to illustrate two axle end caps each having a shaft extending therefrom according to an example embodiment.

FIG. 4A is an elevated perspective view of one of the axle end caps according to an example embodiment.

FIGS. 4B and 4C are side views from different plans of the axle end cap of FIG. 4A.

FIG. 5A is an elevated perspective view of the generator with the axle end cap shown in phantom according to an example embodiment.

FIG. 5B is a side view of the generator and axle end cap of FIG. 5A.

FIG. 6A is a perspective view of a rotor assembly of the generator according to an example embodiment.

FIG. 6B is a side view of the rotor assembly of FIG. 6A.

FIG. 7 is a perspective view of the rotor assembly of FIG. 6A and further including a plurality of bearing assemblies according to an example embodiment.

FIG. 8 is an elevated perspective view of the rotor assembly of FIG. 6A and bearing assemblies of FIG. 7 and further including a portion of a stator assembly according to an example embodiment.

FIG. 9 is an elevated perspective view of a housing section that is part of the stator assembly according to an example embodiment.

FIG. 10 is a side view of the portion of the rail car including the side frame and two wheels of FIG. 2A with the two generators removed to illustrate two intermediate components mounted to the two axle end caps (partially shown), each intermediate component includes a shaft extending therefrom according to an example embodiment.

FIGS. 11A-11C are views of one of the intermediate components of FIG. 10 including the shaft according to an example embodiment.

FIG. 12 is an elevated perspective view of another embodiment of the axle end cap and shaft according to another example embodiment.

FIG. 13 is side view of a side frame and two wheels with two generators coupled to two axles similar to FIG. 2A but with stator assemblies of the two generators coupled back to one or more portions of the rail car to prevent rotation of the stator assembly.

FIG. 14 is a block schematic diagram of electronics according to an example embodiment.

FIG. 15A is a block schematic diagram of a cross-section of another assembly that includes the axle, the wheel, the wheel bearing, the wheel bearing adaptor, the axle end cap and the generator as previously described but including a different linkage assembly relative to the assembly of FIGS. 1A and 1B according to an example embodiment.

FIG. 15B shows the assembly of FIG. 15A as a block schematic diagram from a second perspective but without the wheel or axle illustrated.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

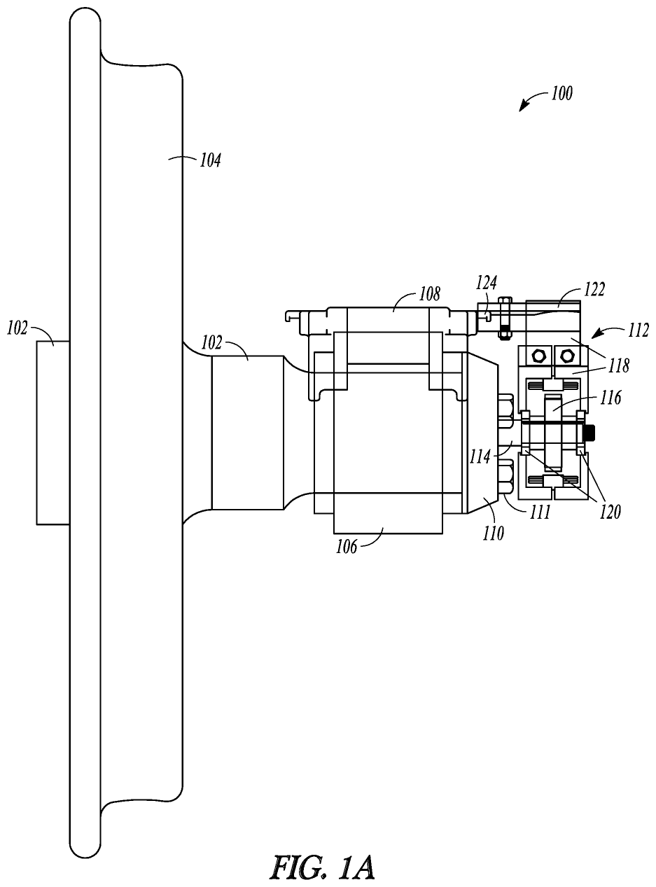

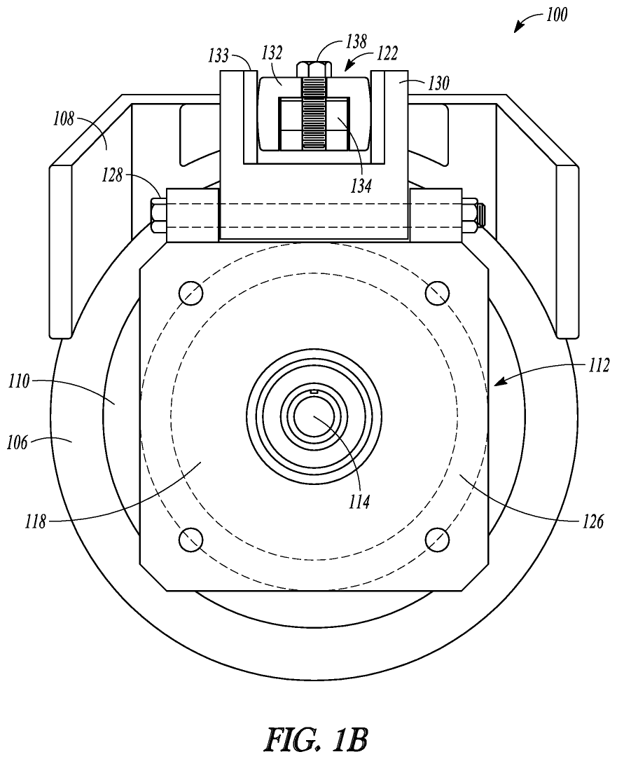

FIG. 1A is a block diagram representation of a cross section of an assembly 100 that can include an axle 102, a wheel 104, a wheel bearing 106, a wheel bearing adaptor 108, an axle end cap 110 and a generator 112. The axle end cap 110 or generator 112 can include a shaft 114. The generator 112 can include a rotor assembly 116, a stator assembly 118, one or more bearing assemblies 120 and a linkage assembly 122.

FIG. 1A illustrates the relative positions of the generator 112 with respect to the axle 102, the wheel 104, the wheel bearing 106 and other components. The generator 112 can be disposed outward of the rail car from the axle 102. In particular, the generator 112 can extend outward of the rail car from the axle 102 a distance. This distance can be less than 5 inches according to some embodiments. As will be explained in further detail, the generator 112 can be mounted to the axle 102 via the shaft 114.

As shown in FIG. 1, the axle 102 is rotatable along with the wheel 104 and portions (e.g., an inner race assembly) of the wheel bearing 106. Thus, the axle 102, wheel 104, portions of the wheel bearing 106 and axle end cap 110 are connected together. Additionally, the shaft 114 can be connected to be rotatable with the axle 102 via the axle end cap 110. Stationary portions of the rail car include portions (an outer race assembly) of the wheel bearing 106 and the bearing adaptor 108. The wheel bearing 106 and the bearing adaptor 108 can support the rail car on the axle 102.

The shaft 114 can be a stub shaft that connects to or can be an integral part of the axle end cap 110. The axle end cap 110 can be removeably connected to the axle 102 via one or more fasteners 111 (only two are shown in FIG. 1A). An axis of rotation of the shaft 114 corresponds to that of the axle 102. The shaft 114 extends outward from the axle end cap 110 and is coupled with the generator 112. More particularly, the generator 112 can be configured to mount on the shaft 114. A fastener (not shown) such as a nut can couple to an outer end portion of the shaft 114 to secure the generator 112 to the shaft 114. Such mounting can be via the rotor assembly 116, which can connect to the shaft 114 so as to be rotatable therewith.

The stator assembly 118 can be disposed outward of the shaft 114 and a set of magnets (illustrated but numbered and shown in further detail subsequently) carried by the rotor assembly 116. The stator assembly 118 can be disposed to interface with and surround the rotor assembly 116. The stator assembly 118 can be coupled to the rotor assembly 116 via the one or more bearing assemblies 120. More particularly, the stator assembly 118 can be mounted on one or more bearing assemblies 120. The one or more bearing assemblies 120 can be mounted on the rotor assembly 116 and/or shaft 114. The linkage assembly 122 can interface with the stator assembly 118. Such interface may not comprise a rigid connection but rather can have a small gap to allow for some small degree of relative movement between the stator assembly 118 and the linkage assembly 122. The linkage assembly 122 can connect to the bearing adaptor 108 or other stationary portion(s) of the rail car and can be configured as subsequently shown to prevent rotation of the stator assembly 118. In particular, the linkage assembly 122 can be configured to connect to a lift ear 124 of the bearing adaptor 108.

In operation, the rotor assembly 116 rotates with the axle 102 via the shaft 114. This can turn a set of magnets (illustrated but numbered and shown in further detail subsequently) that are mounted to the rotor assembly 116. The stator assembly 118 can include the set of coils supported by portions of the stator assembly 118. This set of coils can be located proximate the set of magnets with a gap therebetween. This gap can be maintained by the one or more bearing assemblies 120. Rotation of the rotor assembly 116 with respect to the stator assembly 118 causes electrical current to be generated via the interaction of the coils, which may have ferrite cores, with the magnet fields generated by the magnets. The magnets can comprise permanent magnets. An electrical conductor (illustrated but numbered and shown in further detail subsequently) can be coupled to the set of coils, which are also electrically coupled to each other to provide the generated electricity to the rail car. The conductor may include a harness with plug connector or quarter turn connector to allow ease of coupling to distribute power to a rail car.

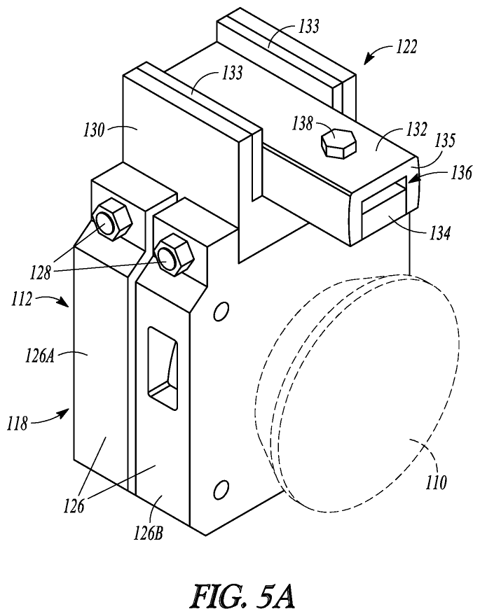

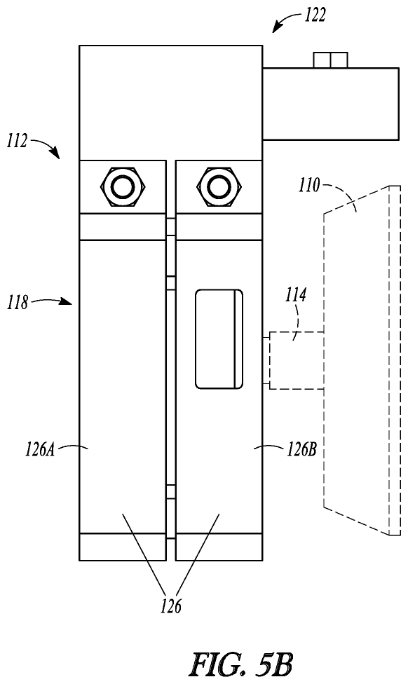

FIG. 1B shows the assembly 100 from an end view but without the wheel or axle as was shown in FIG. 1A. Thus, FIG. 1B shows the wheel bearing 106, the wheel bearing adaptor 108, the axle end cap 110, the generator 112 and the shaft 114. FIGS. 1B, 5A and 5B show a housing 126 of the stator assembly 118 and the linkage assembly 122. FIGS. 5A and 5B show the axle end cap 110 and shaft 114 (FIG. 5B) in phantom.

FIG. 1B and FIGS. 5A and 5B show that portions of the stator assembly 118 such as the housing can be connected together via plurality of fasteners 128 (a bolt and nut) that are configured to extend through portions of the housing 126 and a yoke 130. The housing 126 at a top portion receives the plurality of fasteners 128 and can also be configured to receive the yolk 130 (a portion of the stator assembly 118). The yoke 130 may not be utilized in all embodiments. For example, the top portion of the housing 126 could be configured to interface with the linkage assembly 122. In other embodiments, the configuration of the yoke and strut can be reversed such that the stator assembly 118 has no yoke but a male projection and the strut has two projections similar to the yoke that receive the male projection of the stator assembly 118 therebetween.

Referring now to FIGS. 5A and 5B, the housing 126 can comprise a multi-piece housing having two pieces 126A and 126B. These pieces 126A and 126B are designed to interface with one another and are configured to capture portions of the stator assembly 118 and the rotor assembly (not shown) therein. The two pieces 126A and 126B can connect together in some cases. Each of the pieces 126A and 126B can be connected to the yolk 130 by a dedicated one of the plurality of fasteners 128.

Referring to FIGS. 1B and 5A, the yolk 130 can comprise a generally U shaped component that is configured to receive a strut 132 of the linkage assembly 122 therein. A liner 133 of a compressible material (e.g., foam, rubber or the like) can be provided between the yolk 130 and the strut 132 in some cases. The compressible material can eliminate a gap between the yolk 130 and the strut 132 such that some degree of contact between the liner 133 and the strut 132 is present.

The strut 132 can extend from the yolk 130 inward above the axle end cap 110. The strut 132 can be configured to couple to the bearing adaptor 108 via the lift ear 124 as previously show in FIG. 1A. More particularly, the strut 132 can be configured as a two-piece assembly and can include a first member 134 and a second member 135 (FIG. 5A). Together the first member 134 and the second member 135 can form a small opening 136 (FIG. 5A) at the ends thereof. The first member 134 can have a hooked tip portion for receiving and mating with the lift ear 124. The first member 134 can be coupled to the second member 135 of the strut 132 via bolt 138 or other fastener. The bolt 138 can be adjusted to tighten or loosen the first member 134 relative to the second member 135. This allows the position of the first member 134 to be adjusted relative to the second member 135. The bolt 138 via the first member 134 can exert a clamping force on the lift ear 124 (FIG. 1A), which can be received between the first member 134 and the second member 135 via opening 136 (FIG. 5A).

In abbreviated recap, the linkage assembly 122 can include the strut 132, which can be received by and interface with the yoke 130. In turn, the yoke 130 can be a portion of the stator assembly 118. The liner 133 can be disposed within the yoke 130 between the yoke 130 and the strut 132. The strut 132 can be configured to couple with the lift ear 124 (FIG. 1A) of the bearing adaptor 108 according to some embodiments. Thus, as discussed above, the linkage assembly 122 (strut 132) can extend from stationary portion(s) of the rail car to closely interface with the stator assembly 118 (yoke 130). The linkage assembly 122 can be used to maintain a position of the stator assembly 118 (e.g., prevent the stator assembly 118 from rotating with the rotor assembly). However, as discussed above and according to one embodiment, the generator 112 is supported entirely by the shaft 114, which is coupled to the axle rather than the stationary portion(s) of the rail car.

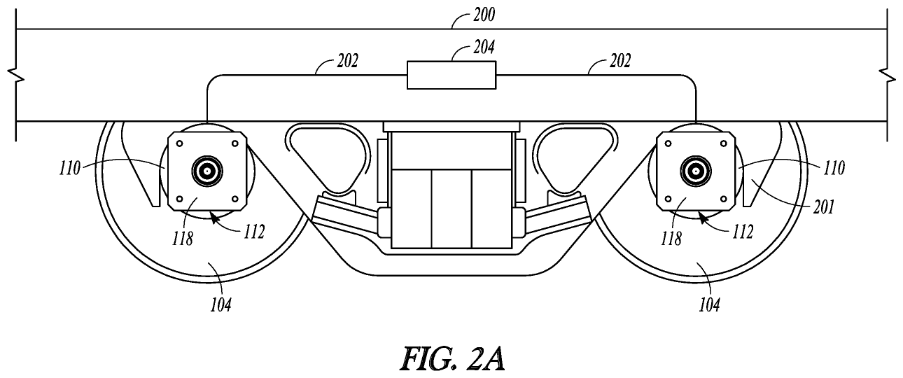

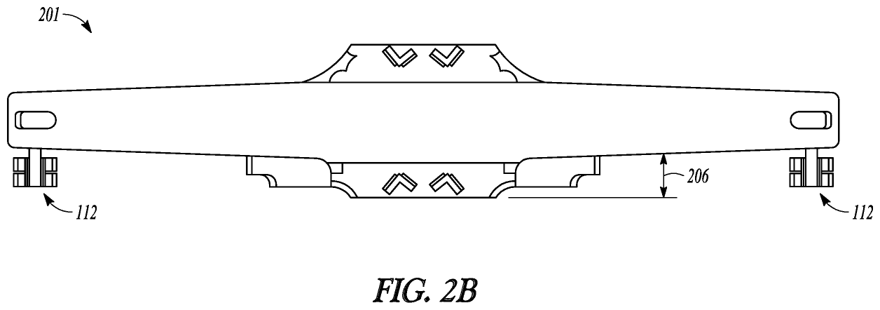

FIG. 2A shows a highly schematic portion of a rail car 200 with two generators 112 installed thereon from a side view. The rail car 200 includes two wheels 104 as previously and two axle end caps 110 (only partially shown) as previously illustrated and described. The two generators 112 can be coupled to two axles (not shown) via the two axle end caps 110.

The rail car 200 may be supported on a side frame 201 by gravity, without the use of special fasteners. Such support makes it easy to replace the side frame 201 and allows for some degree of shifting of the bearing 106 (FIG. 1A) relative to the side frame 201. Electrical conductors 202 can be attached to the generators 112, in particular to the stator assemblies 118 thereof. The electrical conductor 202 can be coupled to the set of coils carried by each of the stator assemblies 118 to provide the generated electricity from the generators 112 to the rail car 200. In some cases, a first electrical conductor can be used on each of the generators 112 that can be adapted to be compatible with one or more conductors on the rail car 200. For example, a harness with plug connector, or quarter turn connector may be used to easily couple the conductors from the generators 112 to those of the rail car 200.

The electrical conductors 202 can provide electrical power to car supported electronics 204, which may include a microprocessor based controller to be used for sensing the condition of the car, identification of the car, and other functions requiring power to operate. In one embodiment, electrical pulses from the generators 112 can be counted by the electronics 204 to help identify a broken axle or other conditions. Still further, the electronics 204 may be used to release air from airbrakes to engage the brakes on each car upon electrical or wireless command from an operator.

In various embodiments, each generator 112 can be capable of operating as a single device, or with combinations of more than one, within a rail car truck or within multiple trucks within the rail car 200. Further still, when the rail car 200 is not moving the generator 112 will not be providing pulses/electrical energy to the electronics and will allow the electronics go into a sleep mode, and other electrical devices to be de-activated, such that a reduced level of energy will be drawn from the battery. When the rail car 200 begins to move the pulses/electrical energy from the generator 112 will provide energy to the electronics and will cause the electronics to awake and go into normal operational state and other electrical devices will be operational.

In one embodiment, a microprocessor in the electronics 204 receives a pulse count representative of pulses from one or more generators for the rail car 200. If no pulses are received after a predetermined amount of time, such as one minute or more for example, the microprocessor may enter a sleep mode or other reduced power consumption mode. Such a mode may include the processor performing a reduced set of functions, such as simply monitoring for pulses from one or more generators. Other functions that occur in a normal mode of operation that may or may not be performed in the sleep mode include but are not limited to RF transceiver functions, temperature sensing, acceleration sensing, and others. When an event, such as a pulse or multiple pulses are detected, which normally correspond to the associated car moving again are detected, the microprocessor may wake up and operate in a normal power consumption mode.

In a further embodiment, the microprocessor may receive indications of pulses from one or more generators, count the pulses, and compare the number of pulses per unit of time to each other or to a known speed of the car/train. Such pulses counts can be used to determine the speed of each corresponding wheel and can indicate faults, such as an axle not rotating at the same speed as the car is going. A sudden change in speed can also be detected, such as going rapidly from a normal speed, such as 60 miles per hour to zero. Such a change can be indicative of a frozen brake or a generator fault, and can be communicated to a locomotive via the RF transceiver.

FIG. 2B is a top view of a portion of the side frame 201 and generators 112 from FIG. 2A. However, the wheels 104 and other components previously discussed in reference to FIG. 2A are not illustrated in FIG. 2B.

The side frame 201 is configured to receive the axle and wheels as previously illustrated in FIG. 2A via connection to the wheel bearing (FIG. 1A). Thus, the side frame 201 can be configured to couple with the wheel bearings 106 and wheel bearing adaptors 108 (shown previously in FIG. 1A). The side frame 201 is a non-rotating stationary part of the rail car 200 to which the axles 102, wheels 104 and other components attach via the wheel bearings 106 and the wheel bearing adaptors 108. The side frame 201 can be lifted free of the wheels 104, wheel bearings 106 and bearing adaptor 108 allowing them to be easily replaced when damaged, or otherwise nearing the end of their useful life.

In the embodiment of FIG. 2B, the axial profile of the generators 112 does not extend beyond an axial profile of the side frame 201 as indicated at 206 in FIG. 2B. The generators 112 in one embodiment each have an axial dimension of less than about 5 inches such that it does not extend beyond the axial profile of the side frame 201, or minimally extends a distance beyond that does not pose a significant additional risk of damage. Thus, the generator 112 extends outward of the rail car 200 from the axle end cap 110 (FIG. 1A) a distance of less than 5 inches according to one embodiment.

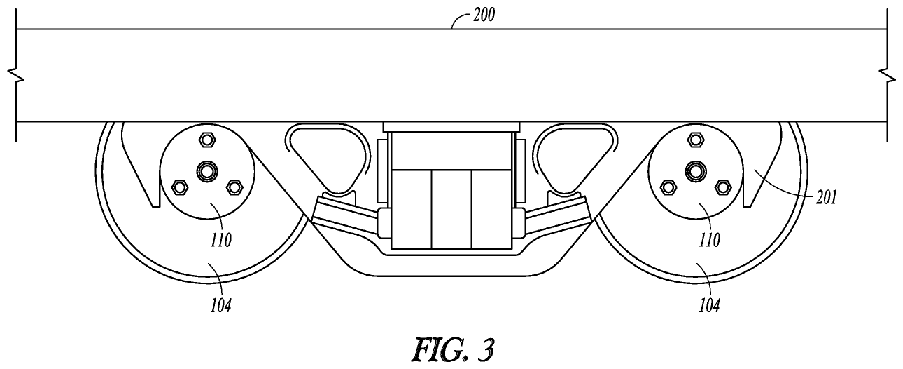

FIG. 3 shows the portion of the rail car 200 previously described in reference to FIG. 2A from the same perspective but with two generators 112 (FIG. 2A) removed to better illustrate the axle end caps 110, wheels 104 and the side frame 201. According to the example of FIG. 3, the axle end caps 110 are connected to the axle (not shown) via the plurality of fasteners 111 (previously also shown in FIG. 1A). According to the example of FIG. 3, each of the axle end caps 110 includes the shaft 114. The shaft 114 co-rotates with the associated axle 102 (FIG. 1A) via the associated axle end cap 110.

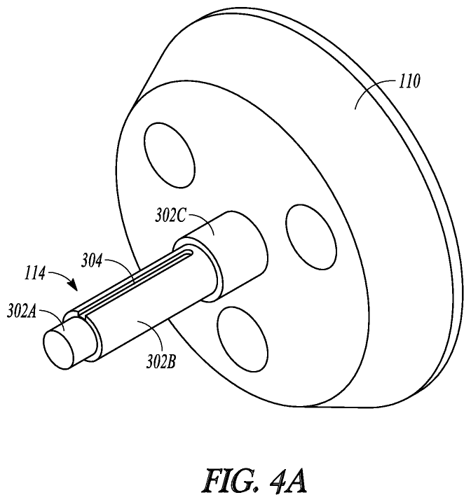

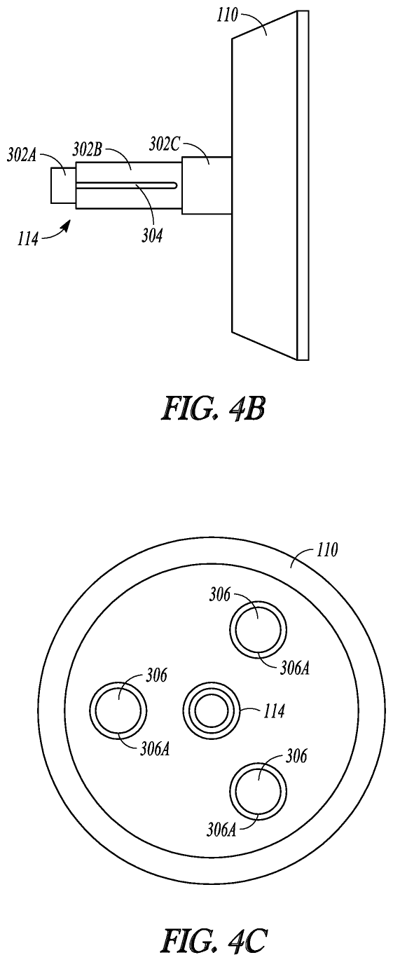

FIGS. 4A-4C show one example embodiment of the axle end cap 110 with the shaft 114. The shaft 114 of this embodiment is an integral part of the axle end cap 110. As shown in FIGS. 4A and 4B, the shaft 114 can include several sections 302A, 302B and 302C. Outermost section 302A can be configured with threading to couple with a fastener (not shown) such as a nut to secure the generator to the shaft 114. Intermediate section 302B can include a coupling feature 304 such as a key for connecting to the rotor assembly 116 (FIG. 1A). Inner section 302C can be designed to space the generator away from the axle end cap 110 a desired distance to provide access to the fasteners 111 (FIG. 1A).

As shown in FIG. 4C, a plurality of holes 306 in the axle end cap 110 can each be configured with a taper 306A. According to some examples, the plurality of fasteners 111 each can be provided with tapered shaft configured for insertion and mating with one of the plurality of holes 306. Thus, the plurality of fasteners 111 can be configured as lug nuts according to some embodiments to center the axle end cap 110 on the axle 102 (FIG. 1A). Three such holes 306 can be utilized and can be arranged in a triangle as shown in FIG. 4C, corresponding to one standard attachment mechanism for prior axle end caps. A washer may be positioned between the fasteners 111 (bolt head) and the plate in some cases.

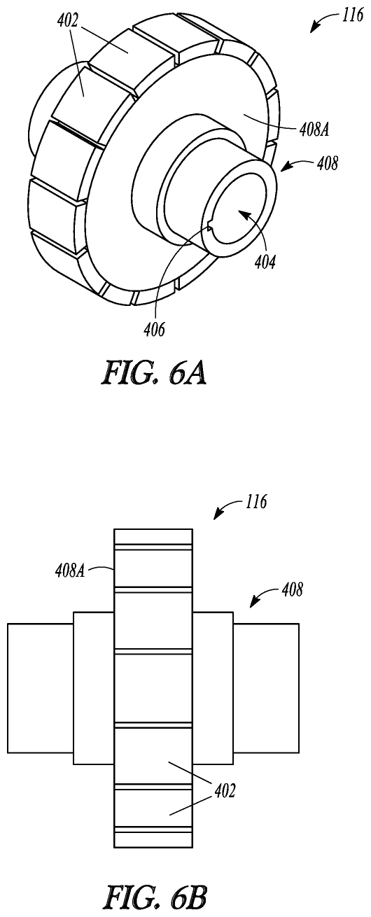

FIGS. 6A and 6B show the rotor assembly 116 according to one example. The rotor assembly 116 can be configured to connect to the shaft 114 (FIGS. 1A and 4A-4C) and can support a set of magnets 402 in a spaced relationship from the shaft 114. More particularly, as shown in FIG. 6A, the rotor assembly 116 can include a passage 404 configured to receive the shaft 114 and a coupling feature 406 configured to mate or otherwise connect with the coupling feature 304 (FIGS. 4A and 4B) of the shaft 114. The rotor assembly 116 can also include a plurality of sections 408 including an intermediate section 408A to which the set of magnets 402 can be mounted. According to other embodiments, the shaft 114 can be part of the rotor assembly 116 rather than a part of the axle end cap 110.

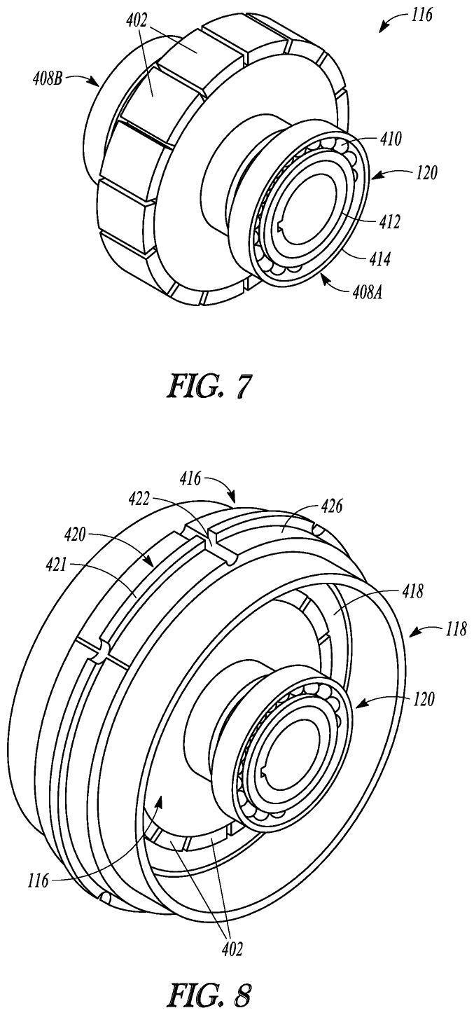

FIG. 7 shows the rotor assembly 116 and the set of magnets 402 from FIGS. 6A and 6B and further illustrates the one or more bearing assemblies 120. The one or more bearing assemblies 120 are configured to mount on the rotor assembly 116 and maintain a desired gap between the set of magnets 402 and a set of coils 418 (FIG. 8). In the embodiment of FIG. 7, the one or more bearing assemblies 120 comprise a first bearing assembly 408A and a second bearing assembly 408B disposed at or adjacent either end of the rotor assembly 116. In particular, the one or more bearing assemblies 120 can be disposed between the rotor assembly 116 and the stator assembly 118 (FIGS. 1A, 5A and 5B).

The one or more bearing assemblies 120 can comprise ball bearings according to the illustrated embodiment. Thus, the one or more bearing assemblies 120 each include balls 410, an inner race 412 and an outer race 414. However, other types of bearings are contemplated in other embodiments such as tapered roller bearings, radial tapered roller bearings, and dual race roller bearings. Off the shelf, non-integrated bearing assemblies may also be used.

FIG. 8 shows the rotor assembly 116, the set of magnets 402 and one of the one or more bearing assemblies 120 of FIGS. 6A, 6B and 7 and further illustrates a first portion 416 of the stator assembly 118.

The first portion 416 of the stator assembly 118 is configured to interface with and be spaced from the rotor assembly 116. In particular, the first portion 416 of the stator assembly 118 supports the set of coils 418 in a spaced relationship from the set of magnets 402. The set of coils 418 can be positioned adjacent the set of magnets 402 but spaced therefrom by a desired gap. This allows for rotation of the set of magnets 402 with the rotor assembly 116. Electricity can be generated when the set of magnets 402 rotates relative to the set of coils 418. The radial distance, as measured from the set of coils 418 to the set of magnets 402, can be minimized to optimize interaction of the coils with the magnetic fields and hence generation of electricity due to relative motion between the magnets and coils.

The set of magnets 402 can comprise permanent magnets. Rotation of the rotor assembly 116 with respect to the stator assembly 118 causes electrical current to be generated via the interaction of the set of coils 418, which may have ferrite cores, with the magnet fields generated by the set of magnets 402. An electrical conductor 202 (previously illustrated in reference to FIG. 2A) is coupled to the set of coils 418, which are also electrically coupled to each other to provide the generated electricity to the rail car.

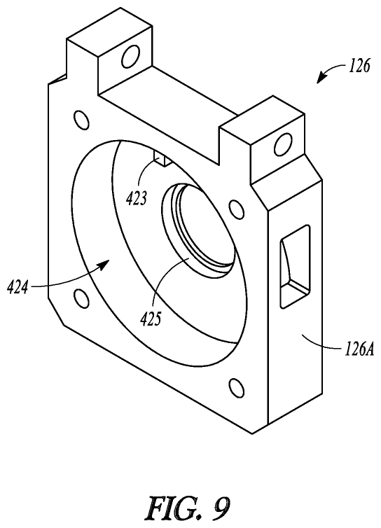

In the embodiment of FIG. 8, the first portion 416 of the stator assembly 118 can be configured to connect with other portions of the stator assembly such as the two pieces 126A and 126B of the housing 126 of FIGS. 1B, 5A and 5B. The housing 126 is also shown in FIG. 9 and comprises one of two pieces 126A previously illustrated in the above referenced FIGS. 1B, 5A and 5B. The housing 126 can be configured with the two pieces to capture and contain the first portion 416 therein. In some cases, the first portion 416 can include a collar 420 with a lip 421 designed to space apart the two pieces of the housing 126. As shown in FIG. 8, the collar 420 can include one or more coupling features 422. The housing 126 in FIG. 9 can include one or more coupling features 423 designed to mate or otherwise connect with the coupling features 422 of the collar 420.

The housing 126 can include an interior cavity 424 (shown in FIG. 9) configured to receive a first side portion 426 of the collar 420 and first portion 416. As shown in FIG. 9, the interior cavity 424 can also be designed to receive the one or more bearing assemblies 120 (FIG. 8) therein. The walls 425 of the housing 126 can be sized and shaped to couple with the outer race 414 (FIG. 7) of the one or more bearing assemblies 120. Thus, the housing 126 and other portions of the stator assembly 118 can be supported on the one or more bearing assemblies 120.

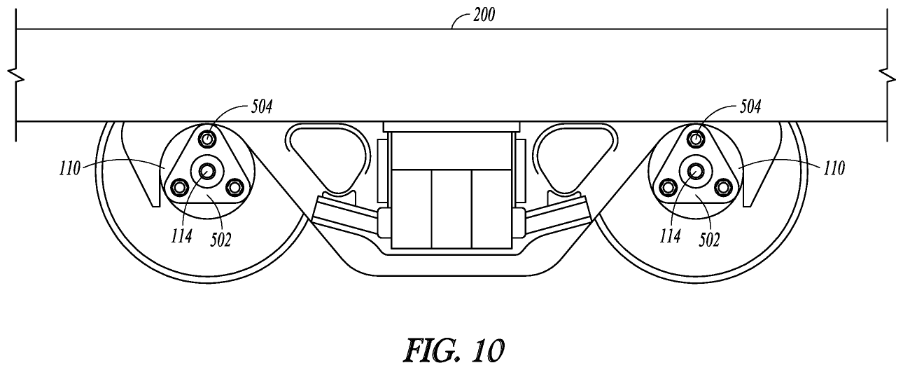

FIG. 10 shows the portion of the rail car 200 previously described in reference to FIG. 2A from the same perspective but with the two generators 112 (FIG. 2A) removed to better illustrate two intermediate components 502. As shown in FIG. 10, each of the intermediate components 502 can couple to a respective one of the axle end plates 110 via fasteners 504. Rather than being a part of the axle end plates 110 as in prior embodiments, the shaft 114 as previously described can be part of the intermediate component 502.

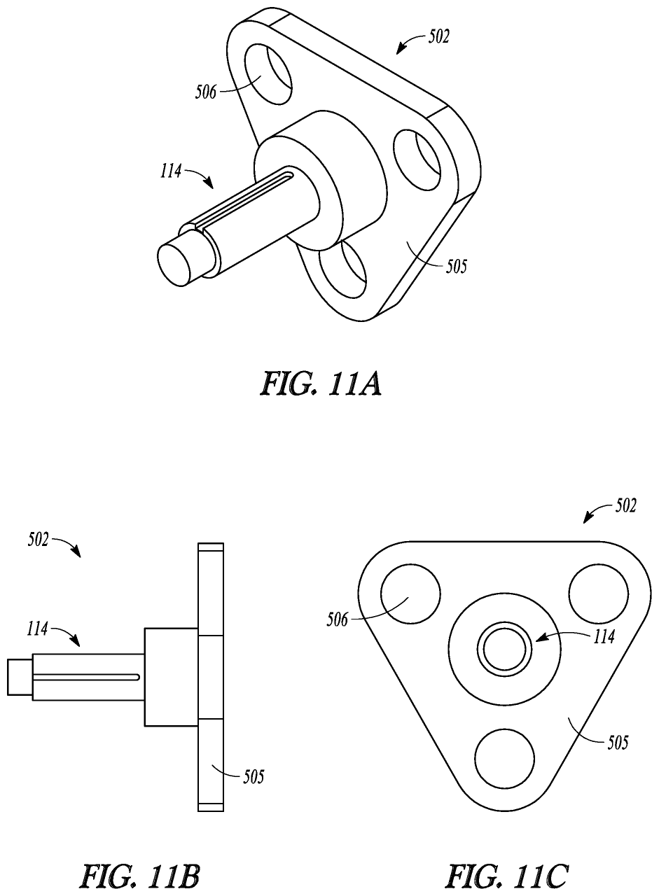

FIGS. 11A-11C show an example of the intermediate component 502 in further detail. The intermediate component 502 can include a plate 505 and the shaft 114. The shaft 114 can be constructed in the manner previously described. As shown in FIG. 11C, the plate 505 can include thru holes 506 configured to receive the fasteners 504 to connect the intermediate component 502 to the axle end cap 110.

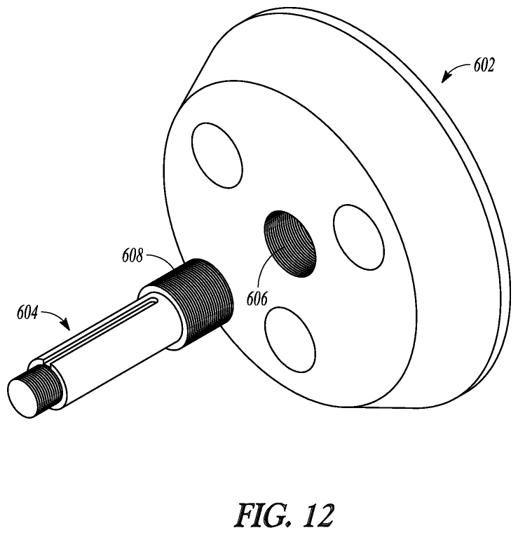

FIG. 12 shows a second axle end cap 602 and a shaft 604 according to an alternative embodiment. The second axle end cap 602 is provided with a threaded bore 606 configured to engage a threaded portion 608 of the shaft 604. Thus, the shaft 604 can be a part of the rotor assembly as previously described and can be configured to connect back to the second axle end cap 602 via the threaded portion 608 that couples with the threaded bore 606.

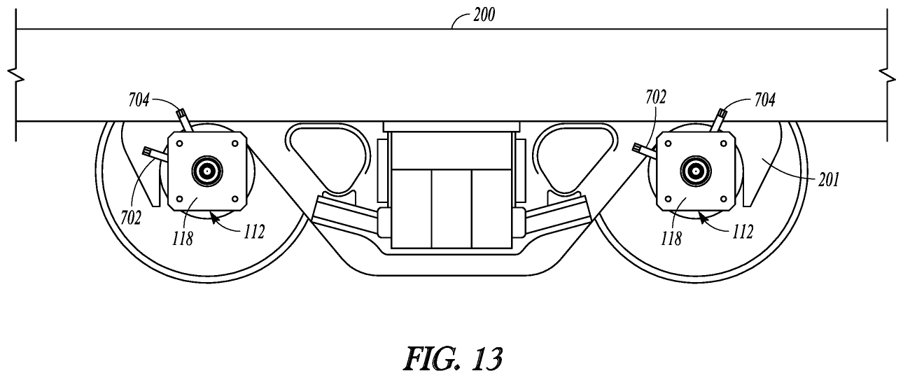

FIG. 13 shows the portion of the rail car 200 previously described in reference to FIG. 2A from the same perspective but with the two generators 112 coupled to the rail car 200 to prevent rotation of the two generators 112 in locations other than the bearing adaptor 108 (FIG. 1A). In particular, the two generators 112 are illustrated as being coupled to the side frame 201 via linkages 702 to prevent rotation. Additionally or alternatively, linkages 704 can be used to connect with other portions of the rail car 200. Such linkages 702, 704 can comprise cables, members, struts, chain, rope or the like.

The linkages 702, 704 can extend both radially and/or axially to make a suitable engagement to desired portions of the rail car 200 that do not rotate with the axle. The linkages 702, 704 can be configured to prevent rotation of the stator assembly 118, while other portions of the assembly (including rotor portions of the generator 112) rotate with the axle.

A linkage (e.g., linkage assembly 122 and/or linkages 702, 704) that allows for some degree of movement of the stator assembly 118 relative to the rail car 200 can thereby be provided. This allows some degree of variation of position between the generator 112 and the non-rotating components of the rail car 200. The linkage allows for variation in position of the axle. The mounting of the generator 112 with some degree of freedom of movement via linkage can reduce stress on the wheel bearings 106 (FIG. 1A). Additionally, this arrangement (rather than fixed, inflexible relationship between the generator 112 and the non-rotating components) can avoid other negative drawbacks such as undesirable stress on the wheel bearing 106, significant separation of the magnet(s) and the induction coil(s) which would decrease the efficiency of the generator, etc.

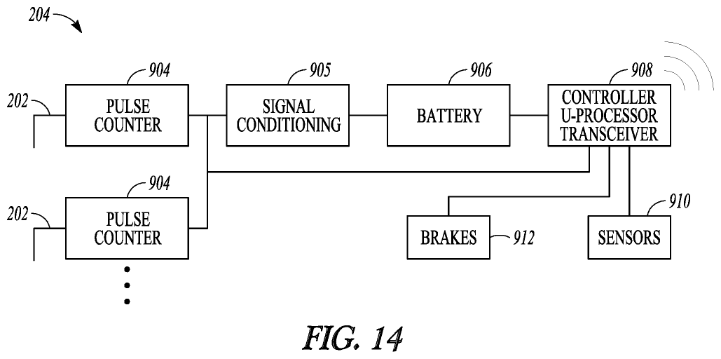

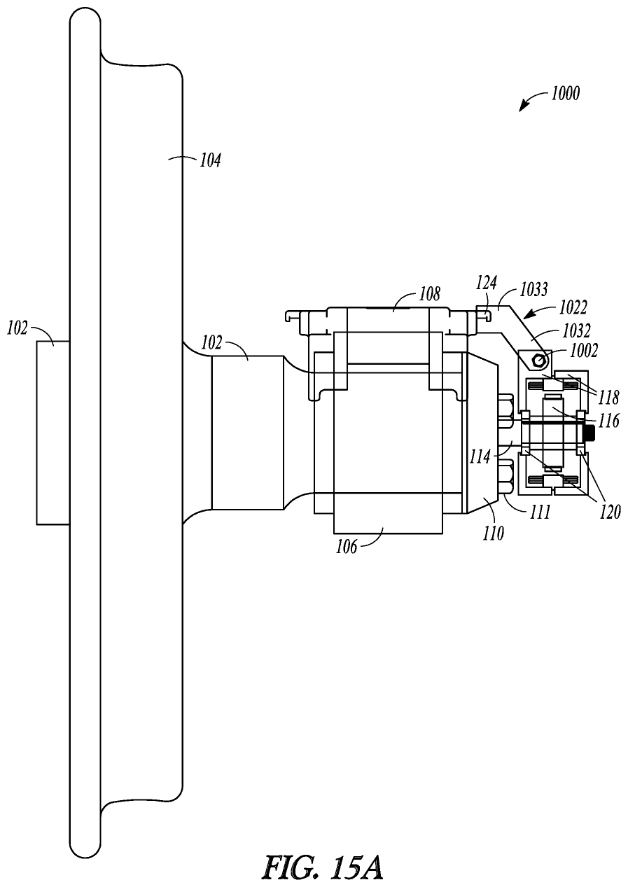

FIG. 14 is a block schematic diagram of the electronics 204 (previously shown and described in reference to FIG. 2A) according to an example embodiment. A conductor 202 is shown for multiple wheels. There may be generators coupled to every wheel or selected wheels on a rail car in various embodiments. Each conductor 202 from a separate generator in one embodiment is coupled to a pulse counter 904. While two are shown, there may be as many used as there are generators for a rail car. Once the pulses are counted, they are provided to signal conditioning circuitry 905 to provide a current and voltage suitable for charging a battery 906. The battery 906 provides power to a controller 908, which may include a microprocessor and transceiver, as well as other circuitry suitable for receiving signals from sensors 910 and controlling brakes 912.

According to one example embodiment a method is disclosed. The method includes rotating an axle having a generator coupled to the axle via a stub shaft, rotating the stub shaft to rotate a set of magnets of the generator, preventing a stator assembly of the generator from rotating, and supporting a set of coils with the stator assembly proximate the set of magnets, the set of coils positioned to generate electricity as the set of magnets rotate proximate to the set of coils.

According to another example embodiment, a controller is disclosed. The controller includes an input coupled to a generator mounted to an axle for a rail car. The input provides pulses of electricity generated by the generator as the axle turns, electronic circuitry to execute a pulse counting module coupled to the input and performing a method including counting pulses per unit of time, placing the electronic circuitry in a sleep mode if no pulses or electrical energy in any form is received for a predetermined time, and waking up the electronics when one or more pulses are received while in sleep mode.

According to yet another example embodiment, a controller is disclosed. The controller includes an input coupled to a generator mounted to an axle for a rail car wheel. The input provides electrical energy generated by the generator as the axle turns and electronic circuitry coupled to the input to perform a method. The method includes detecting electrical energy provided on the input, placing the electronic circuitry in a sleep mode if no electrical energy is received for a predetermined time, and waking up the electronics when electrical energy is detected on the input while in sleep mode.

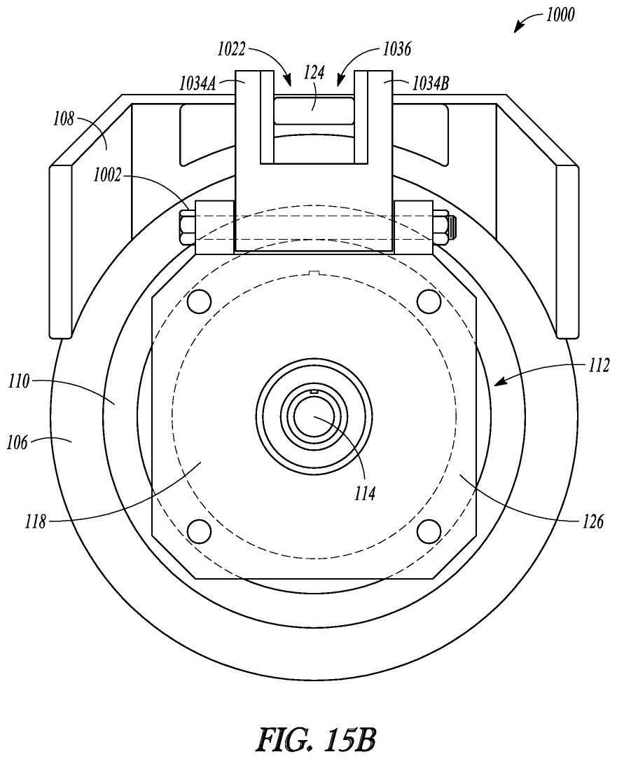

FIG. 15A shows a block diagram representation of a cross section of an assembly 1000. The assembly 1000 can be identical to the assembly 100 of FIGS. 1A and 1B other than the differences specifically noted below. Thus, the assembly 1000 can include an axle 102, a wheel 104, a wheel bearing 106, a wheel bearing adaptor 108, an axle end cap 110 and a generator 112. The axle end cap 110 or generator 112 can include a shaft 114. The generator 112 can include a rotor assembly 116, a stator assembly 118, and one or more bearing assemblies 120.

As shown in FIG. 15B, the assembly 1000 is illustrated from an end view but without the wheel or axle as was shown in FIG. 15A. Thus, FIG. 15B shows the wheel bearing 106, the wheel bearing adaptor 108, the axle end cap 110, the generator 112 and the shaft 114. FIGS. 15B, 5A and 5B show a housing 126 of the stator assembly 118. FIG. 15B shows portions the axle end cap 110 and shaft 114 with some portions shown in phantom.

In the embodiment of FIGS. 15A and 15B, the assembly 1000 differs from the assembly 100 in that it includes a modified linkage assembly 1022. In particular, the yolk 130 (FIG. 1A) previously utilized in the assembly 100 is eliminated in the embodiment of FIGS. 15A and 15B. The linkage assembly 1022 can be directly coupled to the stator assembly 118 such as via a fastener(s) 1002 (e.g., a bolt and nut). Indeed, the linkage assembly 1022 may only be coupled to one of the housings of the stator assembly 118.

As best shown in FIG. 15A, the linkage assembly 1022 can include a yoke linkage 1032 that extends upward and inward from the attachment to the fastener 1002. The yoke linkage 1032 can be configured to couple with the bearing adaptor 108 via the lift ear 124. Thus, the yoke linkage 1032 can extend inward and upward above the axle end cap 110. As is best shown in FIG. 15B, the yoke linkage 1032 can include projection arms 1034A and 1034B and a recess 1036 that is configured to receive the lift ear 124 therein. In some embodiments a liner (shown in FIG. 15B but not specifically numbered) can be disposed within the recess 1036 of the yoke linkage 1032 so as to be between the yoke linkage 1032 and the strut lift ear 124. Thus, the yoke linkage 1032 at the coupling portion 1033 (FIG. 15A) with the lift ear 124 can be configured in a similar manner to the yoke 130 as previously described in reference to FIGS. 1B, 5A and 5B.

The yoke linkage 1032 can be swung out and away from the lift ear 124 to facilitate disassembly of the assembly 1000 if desired. The yoke linkage 1032 can be independent of and not rigidly affixed to any stationary portion of the rail car. Thus, the yoke linkage 1032 allows for variations in relative positions of the axle 102, wheel bearing 106, and generator 112, and may only serve to interfere with and stop any rotation of the generator 112. The yoke linkage 1032 reduces components and simplifies the mechanics of obstructing the rotation of the generator 112 relative to prior linkage assemblies previously described.

In abbreviated recap, the linkage assembly 1022 can include the yoke linkage 1032, which can be directly coupled to the stator assembly 118 at a first end portion with the fastener(s) 1002. In turn, the yoke linkage 1032 can couple in a non-rigid manner with the lift ear 124 at the coupling portion 1033 (FIG. 15A). Thus, as discussed above, the linkage assembly 1022 (yoke linkage 1032) can extend from stationary portion(s) of the rail car to couple with the stator assembly 118. The linkage assembly 1022 using the yoke linkage 1032 can be used to maintain a position of the stator assembly 118 (e.g., prevent the stator assembly 118 from rotating with the rotor assembly).

As discussed above, the generator 112 of FIGS. 15A and 15B can be supported entirely by the shaft 114, which is coupled to the axle rather than the stationary portion(s) of the rail car. In yet other embodiments, the linkage assembly 1022 and yoke linkage 1032 of FIGS. 15A and 15B can be configured to support at least a portion of the weight of the generator 112 in addition to shaft 114.

### EXAMPLES

Example 1 is a generator for a rail car. The generator can comprise: a shaft rigidly coupled to a rotatable axle of the rail car for rotation therewith; a set of magnets coupled to the shaft for rotation therewith; and a stator assembly mounted on one or more bearing assemblies and disposed outward of the shaft and the set of magnets, wherein the stator assembly is independent of a stationary portion of the rail car so as to be moveable relative thereto with movement of the axle. The stator assembly can include: a set of coils supported by the stator assembly and positioned proximate to the set of magnets to generate electricity when the set of magnets rotates; and an electrical conductor coupled to the set of coils to provide the generated electricity to the rail car.

In Example 2, the subject matter of Example 1 optionally includes wherein the stator assembly interfaces with a flexible linkage assembly connected to the stationary portion of the rail car, the linkage assembly is configured to restrain the stator assembly to prevent rotation of the stator assembly but can change position relative to the stator assembly with movement of the stationary portion of the rail car.

In Example 3, the subject matter of Example 2 optionally includes wherein the linkage assembly is connected to one or more of a lifting ear of a bearing adaptor or a side frame of the rail car.

In Example 4, the subject matter of Example 3 optionally includes wherein the linkage assembly includes a strut that is received by a yoke of the stator assembly, and wherein the strut and yoke interface with but are not rigidly connected to one another so as to allow for movement of the stator assembly relative to the rail car.

In Example 5, the subject matter of Example 4 optionally includes wherein the strut extends from the yoke to affix to the lifting ear of the bearing adaptor.

In Example 6, the subject matter of any one or more of Examples 1-5 optionally include a rotor assembly configured to connect to the shaft and support the set of magnets in a spaced relationship from the shaft; and the one or more bearing assemblies disposed between the rotor assembly and the stator assembly and configured to maintain a desired gap between the set of magnets and the set of coils.

In Example 7, the subject matter of any one or more of Examples 5-6 optionally include wherein the stator assembly includes a split housing configured to capture a portion of the stator assembly and the one or more bearing assemblies.

In Example 8, the subject matter of any one or more of Examples 1-7 optionally include an axle end cap having a plurality of spaced apart tapered holes; and a plurality of fasteners each having a tapered shaft configured for insertion into one of the through holes.

In Example 9, the subject matter of any one or more of Examples 1-8 optionally include wherein the shaft comprises at least one of: a part of a rotor assembly and is configured to connect to an axle end cap of the rail car; a stub shaft connected to the axle end cap; or a part of an intermediate component that is coupled to the axle end cap.

In Example 10, the subject matter of any one or more of Examples 1-9 optionally include inches.

Example 11 is a generator mountable to a rail car via an axle end cap. The generator can comprise: a shaft rigidly coupled to a rotatable axle of the rail car via the axle end cap for rotation therewith; a rotor assembly configured to connect to the shaft and support a set of permanent magnets in a spaced relationship from the shaft; and a stator assembly coupled to the rotor assembly via one or more bearing assemblies, wherein the stator assembly is independent of a stationary portion of the rail car so as to be moveable relative thereto with movement of the axle. The stator assembly can include: a set of coils supported by the outer race assembly and positioned proximate to the set of magnets to generate electricity when the inner race rotates; and an electrical conductor coupled to the set of coils to provide the generated electricity to the rail car.

In Example 12, the subject matter of Example 11 optionally includes wherein the stator assembly interfaces with a flexible linkage assembly connected to the stationary portion of the rail car, the linkage assembly is configured to restrain the stator assembly to prevent rotation of the stator assembly but can change position relative to the stator assembly with movement of the stationary portion of the rail car.

In Example 13, the subject matter of Example 12 optionally includes wherein the linkage assembly is connected to one or more of a lifting ear of a bearing adaptor or a side frame of the rail car.

In Example 14, the subject matter of Example 13 optionally includes wherein the linkage assembly includes a strut that is received by a yoke of the stator assembly, and wherein the strut and yoke interface with but are not rigidly connected to one another so as to allow for movement of the stator assembly relative to the rail car.

In Example 15, the subject matter of Example 14 optionally includes wherein the strut extends from the yoke to affix to the lifting ear of the bearing adaptor.

In Example 16, the subject matter of any one or more of Examples 11-15 optionally include wherein the shaft comprises at least one of: a part of the rotor assembly and is configured to connect to the axle end cap of the rail car; a stub shaft connected to the axle end cap; or a part of an intermediate component that is coupled to the axle end cap.

Example 17 is a generator mountable to a rail car. The generator can comprise: a shaft rigidly coupled to a rotatable axle of the rail car for rotation therewith; a rotor assembly configured to connect to the shaft and support a set of permanent magnets in a spaced relationship from the shaft; and a stator assembly coupled to the rotor assembly via one or more bearing assemblies, wherein the stator assembly is independent of a stationary portion of the rail car so as to be moveable relative thereto with movement of the axle; and a linkage assembly. The stator assembly can include: a set of coils supported by the outer race assembly and positioned proximate to the set of magnets to generate electricity when the inner race rotates; and an electrical conductor coupled to the set of coils to provide the generated electricity to the rail car. The linkage assembly can interface with the stator assembly, wherein the linkage assembly is connected to the stationary portion of the rail car, the linkage assembly is configured to restrain the stator assembly to prevent rotation of the stator assembly but can change position relative to the stator assembly with movement of the stationary portion of the rail car.

In Example 18, the subject matter of Example 17 optionally includes wherein the linkage assembly is connected to one or more of a lifting ear of a bearing adaptor or a side frame of the rail car.

In Example 19, the subject matter of Example 18 optionally includes wherein the linkage assembly includes a strut that is received by a yoke of the stator assembly, and wherein the strut and yoke interface with but are not rigidly connected to one another so as to allow for movement of the stator assembly relative to the rail car.

In Example 20, the subject matter of Example 19 optionally includes wherein the strut extends from the yoke to affix to the lifting ear of the bearing adaptor.

In Example 21, the subject matter of any one or more of Examples 17-20 optionally include wherein the shaft comprises at least one of: a part of the rotor assembly and is configured to connect to an axle end cap of the rail car; a stub shaft connected to the axle end cap; or a part of an intermediate component that is coupled to the axle end cap.

In Example 22, the subject matter of Example 21 optionally includes wherein the stub shaft comprises one of an integral part of the axle end cap or a separate component that is connected to the axle end cap.

In Example 23, the subject matter of any one or more of Examples 17-22 optionally include inches.

In Example 24, the subject matter of any one or more of Examples 1-23, wherein the linkage assembly includes a yoke linkage that that rigidly couples to the stator assembly and couples with the lifting ear of the bearing adaptor non-rigidly such that the yoke linkage is configured to allow for movement of the stator assembly relative to the rail car.

Example 25 is a method that can comprise: rotating an axle having a generator coupled to the axle via a stub shaft; rotating the stub shaft to rotate a set of magnets of the generator; preventing a stator assembly of the generator from rotating; and supporting a set of coils with the stator assembly proximate the set of magnets, the set of coils positioned to generate electricity as the set of magnets rotate proximate to the set of coils.

Example 26 is a controller that can comprise: an input coupled to a generator mounted to an axle for a rail car, the input providing pulses of electricity generated by the generator as the axle turns; electronic circuitry to execute a pulse counting module coupled to the input and performing a method comprising: counting pulses per unit of time; placing the electronic circuitry in a sleep mode if no pulses are received for a predetermined time; and waking up the electronics when one or more pulses are received while in sleep mode.

In Example 27, the subject matter of Example 26 optionally includes wherein the electronic circuitry is coupled to multiple inputs from multiple generators on the rail car and detects faults based on counted pulse rates from the multiple generators.

In Example 28, the subject matter of any one or more of Examples 26-27 optionally include wherein the pulse counts are converted to a speed and compared to a known speed of the rail car.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

The following statements are potential claims that may be converted to claims in a future application. No modification of the following statements should be allowed to affect the interpretation of claims which may be drafted when this provisional application is converted into a regular utility application.

1. A generator for a rail car, the generator comprising:
a shaft rigidly coupled to a rotatable axle of the rail car for rotation therewith;
a set of magnets coupled to the shaft for rotation therewith; and
a stator assembly mounted on one or more bearing assemblies and disposed outward of the shaft and the set of magnets, wherein the stator assembly is independent of a stationary portion of the rail car so as to be moveable relative thereto with movement of the axle, the stator assembly including:
a set of coils supported by the stator assembly and positioned proximate to the set of magnets to generate electricity when the set of magnets rotates; and
an electrical conductor coupled to the set of coils to provide the generated electricity to the rail car.

2. The generator of claim 1, wherein the stator assembly interfaces with a flexible linkage assembly connected to the stationary portion of the rail car, the linkage assembly is configured to restrain the stator assembly to prevent rotation of the stator assembly but can change position relative to the stator assembly with movement of the stationary portion of the rail car.

3. The generator of claim 2, wherein the linkage assembly is connected to one or more of a lifting ear of a bearing adaptor or a side frame of the rail car.

4. The generator of claim 3, wherein the linkage assembly includes a strut that is received by a yoke of the stator assembly, and wherein the strut and yoke interface with but are not rigidly connected to one another so as to allow for movement of the stator assembly relative to the rail car.

5. The generator of claim 4, wherein the strut extends from the yoke to affix to the lifting ear of the bearing adaptor.

6. The generator of claim 3, wherein the linkage assembly includes a yoke linkage that that rigidly couples to the stator assembly and couples with the lifting ear of the bearing adaptor non-rigidly such that the yoke linkage is configured to allow for movement of the stator assembly relative to the rail car.

7. The generator of claim 1, further comprising:
a rotor assembly configured to connect to the shaft and support the set of magnets in a spaced relationship from the shaft; and
the one or more bearing assemblies disposed between the rotor assembly and the stator assembly and configured to maintain a desired gap between the set of magnets and the set of coils.

8. The generator of claim 5, wherein the stator assembly includes a split housing configured to capture a portion of the stator assembly and the one or more bearing assemblies.

9. The generator of claim 1, further comprising:
an axle end cap having a plurality of spaced apart tapered holes; and
a plurality of fasteners each having a tapered shaft configured for insertion into one of the through holes.

10. The generator of claim 1, wherein the shaft comprises at least one of:
a part of a rotor assembly and is configured to connect to an axle end cap of the rail car;
a stub shaft connected to the axle end cap; or
a part of an intermediate component that is coupled to the axle end cap.

11. The generator of claim 1, wherein the generator extends outward of the rail car from the axle end cap a distance of less than 5 inches.

12. A generator mountable to a rail car via an axle end cap, the generator comprising:
a shaft rigidly coupled to a rotatable axle of the rail car via the axle end cap for rotation therewith;
a rotor assembly configured to connect to the shaft and support a set of permanent magnets in a spaced relationship from the shaft; and
a stator assembly coupled to the rotor assembly via one or more bearing assemblies, wherein the stator assembly is independent of a stationary portion of the rail car so as to be moveable relative thereto with movement of the axle, the stator assembly including:
a set of coils supported by the outer race assembly and positioned proximate to the set of magnets to generate electricity when the inner race rotates; and
an electrical conductor coupled to the set of coils to provide the generated electricity to the rail car.

13. The generator of claim 12, wherein the stator assembly interfaces with a flexible linkage assembly connected to the stationary portion of the rail car, the linkage assembly is configured to restrain the stator assembly to prevent rotation of the stator assembly but can change position relative to the stator assembly with movement of the stationary portion of the rail car.

14. The generator of claim 13, wherein the linkage assembly is connected to one or more of a lifting ear of a bearing adaptor or a side frame of the rail car.

15. The generator of claim 14, wherein the linkage assembly includes a strut that is received by a yoke of the stator assembly, and wherein the strut and yoke interface with but are not rigidly connected to one another so as to allow for movement of the stator assembly relative to the rail car.

16. The generator of claim 15, wherein the strut extends from the yoke to affix to the lifting ear of the bearing adaptor.

17. The generator of claim 14, wherein the linkage assembly includes a yoke linkage that that rigidly couples to the stator assembly and couples with the lifting ear of the bearing adaptor non-rigidly such that the yoke linkage is configured to allow for movement of the stator assembly relative to the rail car.

18. The generator of claim 11, wherein the shaft comprises at least one of:
a part of the rotor assembly and is configured to connect to the axle end cap of the rail car;
a stub shaft connected to the axle end cap; or
a part of an intermediate component that is coupled to the axle end cap.

19. A generator mountable to a rail car, the generator comprising:
a shaft rigidly coupled to a rotatable axle of the rail car for rotation therewith;
a rotor assembly configured to connect to the shaft and support a set of permanent magnets in a spaced relationship from the shaft; and
a stator assembly coupled to the rotor assembly via one or more bearing assemblies, wherein the stator assembly is independent of a stationary portion of the rail car so as to be moveable relative thereto with movement of the axle, the stator assembly including:
a set of coils supported by the outer race assembly and positioned proximate to the set of magnets to generate electricity when the inner race rotates; and
an electrical conductor coupled to the set of coils to provide the generated electricity to the rail car; and
a linkage assembly interfacing with the stator assembly, wherein the linkage assembly is connected to the stationary portion of the rail car, the linkage assembly is configured to restrain the stator assembly to prevent rotation of the stator assembly but can change position relative to the stator assembly with movement of the stationary portion of the rail car.

20. The generator of claim 19, wherein the linkage assembly is connected to one or more of a lifting ear of a bearing adaptor or a side frame of the rail car.

21. The generator of claim 20, wherein the linkage assembly includes a strut that is received by a yoke of the stator assembly, and wherein the strut and yoke interface with but are not rigidly connected to one another so as to allow for movement of the stator assembly relative to the rail car.

22. The generator of claim 21, wherein the strut extends from the yoke to affix to the lifting ear of the bearing adaptor.

23. The generator of claim 20, wherein the linkage assembly includes a yoke linkage that that rigidly couples to the stator assembly and couples with the lifting ear of the bearing adaptor non-rigidly such that the yoke linkage is configured to allow for movement of the stator assembly relative to the rail car.

24. The generator of claim 19, wherein the shaft comprises at least one of:
a part of the rotor assembly and is configured to connect to an axle end cap of the rail car;
a stub shaft connected to the axle end cap; or
a part of an intermediate component that is coupled to the axle end cap.

25. The generator of claim 24, wherein the stub shaft comprises one of an integral part of the axle end cap or a separate component that is connected to the axle end cap.

26. The generator of claim 19, wherein the generator extends outward of the rail car from the axle a distance of less than 5 inches.

27. A method comprising:
rotating an axle having a generator coupled to the axle via a stub shaft;
rotating the stub shaft to rotate a set of magnets of the generator;
preventing a stator assembly of the generator from rotating; and
supporting a set of coils with the stator assembly proximate the set of magnets, the set of coils positioned to generate electricity as the set of magnets rotate proximate to the set of coils.

28. A controller comprising:
an input coupled to a generator mounted to an axle for a rail car, the input providing pulses of electricity generated by the generator as the axle turns;
electronic circuitry to execute a pulse counting module coupled to the input and performing a method comprising:
counting pulses per unit of time;
placing the electronic circuitry in a sleep mode if no pulses are received for a predetermined time; and
waking up the electronics when one or more pulses are received while in sleep mode.

29. The controller of claim 28, wherein the electronic circuitry is coupled to multiple inputs from multiple generators on the rail car and detects faults based on counted pulse rates from the multiple generators.

30. The controller of claim 28, wherein the pulse counts are converted to a speed and compared to a known speed of the rail car.

31. A controller comprising:
an input coupled to a generator mounted to an axle for a rail car, the input providing electrical energy generated by the axle generator as the wheel turns;
electronic circuitry coupled to the input to perform a method comprising:
detecting electrical energy provided on the input;
placing the electronic circuitry in a sleep mode if no electrical energy is received for a predetermined time; and
waking up the electronics when electrical energy is detected on the input while in sleep mode.
